(19) United States
(12) Patent Application Publication
(10) Pub. No.: US 2020/0218753 A1
(43) Pub. Date: Jul. 9, 2020

(54) METHOD AND SYSTEM FOR ACCESSING IMAGE DATA

(71) Applicant: Ovass Pty Ltd, Halls Head (AU)

(72) Inventors: David James NEWMAN, Perth (AU); Ravi Gopal NICHANI, Perth (AU)

(21) Appl. No.: 16/628,566

(22) PCT Filed: Jul. 4, 2018
(86) PCT No.: PCT/AU2018/050695

§ 371 Date: Jan. 3, 2020

(30) Foreign Application Priority Data
Jul. 4, 2017 (AU) 2017902611

(51) Int. Cl. G06F 16/532; G06F 16/587; G06T 3/40; G06T 7/60; G06T 7/70; G06T 5/50

(52) U.S. Cl. CPC G06F 16/532; G06F 16/587; G06T 3/40; G06T 2207/20221; G06T 7/70; G06T 5/50; G06T 7/60

(57) ABSTRACT

A method of accessing image data comprises receiving a query to access data from a user. The query comprises data parameters comprising one or more geographic areas of the images of the data, and/or one or more time frames for the images of the data. The data query is formatted according a requirement of each of a plurality of data providers. The respective formatted query is sent to each of the data providers. A response is received from each data provider. The response indicates whether the respective data provider has data that meets the respective formatted query. For those data providers that indicate that they have data that meets the respective formatted query, the data that meets the respective formatted query is received using a data transfer protocol suitable for the respective data provider. The retrieved data from the plurality of data providers is collated and sent to the user.

### FIELD OF THE INVENTION

The present invention relates to on-line data access including satellite and aerial data from multiple content providers.

### BACKGROUND TO THE INVENTION

Access to satellite and aerial based data (which may comprise multiple spectral, image and video data types) has become increasing important for the purpose of gaining insights and making decisions from the data and imagery provided. As the amount of content increases so do the possible insights and use-cases for where this content can be applied. Access to and availability of satellite and aerial content is expected to expand massively over the coming years.

Satellite:

There are currently about 300 earth observation satellites orbiting the earth from over 100 different providers. By 2024 this number is expected to increase to over 1700 earth observation satellites and again a large jump in the number of content providers.

Aerial:

There has been an increased demand for aerial and Unmanned Aerial Vehicles (UAV's) (also known as drones) images. It is expected that there will be a significant increase in the use of high altitude UAV's along with more small aircraft based image and video content becoming available.

While the availability of various sources of image data is expected to increase, this also presents a problem. The various content providers have various types of data format, with various types of image (both in spectrum and in resolution) over various geographic areas and various times (of capturing the image). The result is a multi-dimensional array of available data. This problem is compounded because the data is available from different provides in different formats, with different modes of data access, at different costs.

Currently one generally identifies the appropriate (or most appropriate) data provider that provides the best fitting data for the need, purchases access to the data and interfaces to the data repository of the data provider using the appropriate interface of that provider. Often this results in a compromise on the requirements because the data available is limited in terms of times and locations of data capture, and also the nature of the data, such as spectrum of the image(s) and resolution.

Accordingly, getting access to the right data can become difficult.

Further even determining which provider will have the content desired is challenging as for each content provider one must query whether they have images of the desired type, and if so to then purchase access to those images.

In US 2016/0092582, at [0042]: ‘the delivery engine 90 . . . provides the capability to format a finalized query into its delivery format such as zip file, formatted pdf, or any other available presentation format’. It appears to receive one standardized format of a finalized query presented in a required query format, as disclosed at paragraph [0005] of this document: ‘the step of standardizing may include converting queries into standard formats and adding rules for effective searching of each query’. This requires that the data providers accept a standard format of query, which they currently do not accept. This document also does not address the returned data from the various data providers being in various formats.

These problems will only get worse as the number of data providers increases, and the number of data sources increase.

The present invention seeks to address these problems.

Any references to documents that are made in this specification are not intended to be an admission that the information contained in those documents form part of the common general knowledge known to a person skilled in the field of the invention, unless explicitly stated as such.

### SUMMARY OF THE INVENTION

According to the present invention, there is provided a method of accessing image data comprising:

receiving a query to access data from a user, wherein the query comprises data parameters comprising one or more geographic areas of the images of the data, and/or one or more time frames for the images of the data, and/or optionally one or more other parameters of the images of the data, such as resolution or spectrum of the images;

formatting the data query according a requirement of each of a plurality of data providers;

sending the respective formatted query to each of the data providers;

receiving a response from each data provider, where the response indicates whether the respective data provider has data that meets the respective formatted query;

for those data providers that indicate that they have data that meets the respective formatted query, retrieving the data that meets the respective formatted query using a data transfer protocol suitable for the respective data provider;

collating the retrieved data from the plurality of data providers;

optionally, converting the collated data into a common format;

sending the retrieved data to the user.

In an embodiment the requirement of each data provider comprises a query format. In an embodiment the requirement of each data provider comprises the data interface format.

In an embodiment receiving the query of one or more geographic areas comprises receiving, modifying or verifying the size, shape and position of a polygon image on a map so as to indicate the area of interest of the query.

In an embodiment, the retrieved data from each data provider is processed from the respective retrieved format into a format specified in the query before being sent to the user. In an embodiment, the processing comprises stitching together data retrieved from different data providers so as to provide one or more images of a combined geographic area. In an embodiment, the processing comprises changing the resolution of images in data retrieved from different data providers so as to provide images of a consistent resolution. In an embodiment, the processing comprises sequencing images in time order from the different data providers. In an embodiment, the processing comprises combining different spectral images into multi-spectral images, each of the images being of a geographic area in a given time frame from different spectral images from different data providers.

In an embodiment, the received query further comprises a request for future content. In an embodiment, the method further comprises formatting the request for future content according to the requirement of each of the respective data providers. In an embodiment, the method further comprises sending the formatted request for future content to one or more of the data providers, optionally according to a pre-selection criteria. In an embodiment, the pre-selection criteria selects data providers to be omitted from those to which the formatted request for future content is made which are able to be determined in advance will not have be able to provide the future content according to required data parameters required of the future content. In an embodiment, the method further comprises receiving a response from each data provider, where the response indicates whether the respective data provider is able to provide the future content according to the required parameters. In an embodiment, the method further comprises selecting one or more of the data providers to provide the future according to the responses. In an embodiment, the method further comprises retrieving data comprising the future content from the selected providers, as and when it is available.

According to the present invention, there is provided a method of requesting future image data comprising:

receiving a query to access data from a user, wherein the query comprises data parameters comprising one or more geographic areas of the images of the data, and/or optionally one or more other parameters of the images of the data, such as resolution or spectrum of the images;

formatting the data query according to a requirement of each of a plurality of data providers;

sending the respective formatted query to each of the data providers;

receiving a response from each data provider, where the response indicates whether the respective data provider can provide the data that meets the respective formatted query;

for those data providers that indicate that they have data that meets the respective formatted query, retrieving the data that meets the respective formatted query using a data transfer protocol suitable for the respective data provider;

collating the retrieved data from the plurality of data providers;

optionally, converting the collated data into a common format;

sending the retrieved data to the user.

In an embodiment, the received query further comprises a time frame required for the future image data. In an embodiment, the pre-selection criteria selects data providers to be omitted from those to which the formatted request for future content is made which are able to be determined in advance will not have be able to provide the future content according to required data parameters required of the future content. In an embodiment, the method further comprises selecting one or more of the data providers to provide the future according to the responses. In an embodiment, the method further comprises retrieving data comprising the future content from the selected providers, as and when it is available.

According to the present invention, there is provided a system for accessing image data comprising:

a receiver for receiving a query to access data from a user, wherein the query comprises data parameters comprising one or more time frames for the images of the data, and/or one or more geographic areas of the images of the data, and/or optionally one or more other parameters of the images of the data, such as resolution or spectrum of the images;

a first processor for formatting the data query according to a requirement of each of a plurality of data providers;

a transmitter for sending the respective formatted query to each of the data providers;

a receiver for receiving a response from each data provider, where the response indicates whether the respective data provider has data that meets the respective formatted query;

a receiver for retrieving the data that meets the respective formatted query using a data transfer protocol suitable for the respective data provider from those data providers that indicate that they have data that meets the respective formatted query;

a second processor for collating the retrieved data from the plurality of data providers;

optionally, a third processor for converting the collated data into a common format; a transmitter for sending the retrieved data to the user.

According to the present invention, there is provided a system for accessing image data comprising a processor configured to:

receive a query to access data from a user, wherein the query comprises data parameters comprising one or more time frames for the images of the data, and/or one or more geographic areas of the images of the data, and/or optionally one or more other parameters of the images of the data, such as resolution or spectrum of the images;

format the data query according to a requirement of each of a plurality of data providers;

send the respective formatted query to each of the data providers;

receive a response from each data provider, where the response indicates whether the respective data provider has data that meets the respective formatted query;

retrieve the data that meets the respective formatted query using a data transfer protocol suitable for the respective data provider from those data providers that indicate that they have data that meets the respective formatted query;

collate the retrieved data from the plurality of data providers;

optionally, convert the collated data into a common format;

send the retrieved data to the user.

According to the present invention, there is provided a system for accessing image data comprising:

means for receiving a query to access data from a user, wherein the query comprises data parameters comprising one or more time frames for the images of the data, and/or one or more geographic areas of the images of the data, and/or optionally one or more other parameters of the images of the data, such as resolution or spectrum of the images;

means for formatting the data query according to a requirement of each of a plurality of data providers;

means for sending the respective formatted query to each of the data providers;

means for receiving a response from each data provider, where the response indicates whether the respective data provider has data that meets the respective formatted query;

means for retrieving the data that meets the respective formatted query using a data transfer protocol suitable for the respective data provider from those data providers that indicate that they have data that meets the respective formatted query;

means for collating the retrieved data from the plurality of data providers;

optionally, means for converting the collated data into a common format;

means for sending the retrieved data to the user.

According to the present invention, there is provided a computer program embodied in a computer readable tangible media comprising instructions for controlling a computer processor to:

receive a query to access data from a user, wherein the query comprises data parameters comprising one or more time frames for the images of the data, and/or one or more geographic areas of the images of the data;

format the data query according to a requirement of each of a plurality of data providers;

send the respective formatted query to each of the data providers;

receive a response from each data provider, where the response indicates whether the respective data provider has data that meets the respective formatted query;

retrieve the data that meets the respective formatted query using a data transfer protocol suitable for the respective data provider from those data providers that indicate that they have data that meets the respective formatted query;

collate the retrieved data from the plurality of data providers;

send the retrieved data to the user.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### BRIEF DESCRIPTION OF THE DRAWINGS

In order to provide a better understanding of the present invention embodiments will now be described, by way of example only, with reference to the drawings, in which:

FIG. 1 is a schematic diagram of imaging systems in operation around the globe;

FIG. 2 is a schematic block diagram of a system for accessing image data according to an embodiment of the present invention;

FIG. 3 is a block diagram of functional modules of a system according to an embodiment of the present invention;

FIG. 4 is a flow chart of a method of accessing image data according to an embodiment of the present invention;

FIG. 5 is a flow chart of a method of selecting an area of interest performed by a user interface module of block 302 of FIG. 3 according to an embodiment of the present invention;

FIG. 6 is a flow chart of a method of selection of a time period of interest performed by a time frame selection interface of block 304 of FIG. 3 according to an embodiment of the present invention; and

FIG. 7 is a flow chart of a method of search according to defined criteria performed by a query module of block 306 of FIG. 3 according to an embodiment of the present invention.

### DETAILED DESCRIPTION OF EMBODIMENT OF THE INVENTION

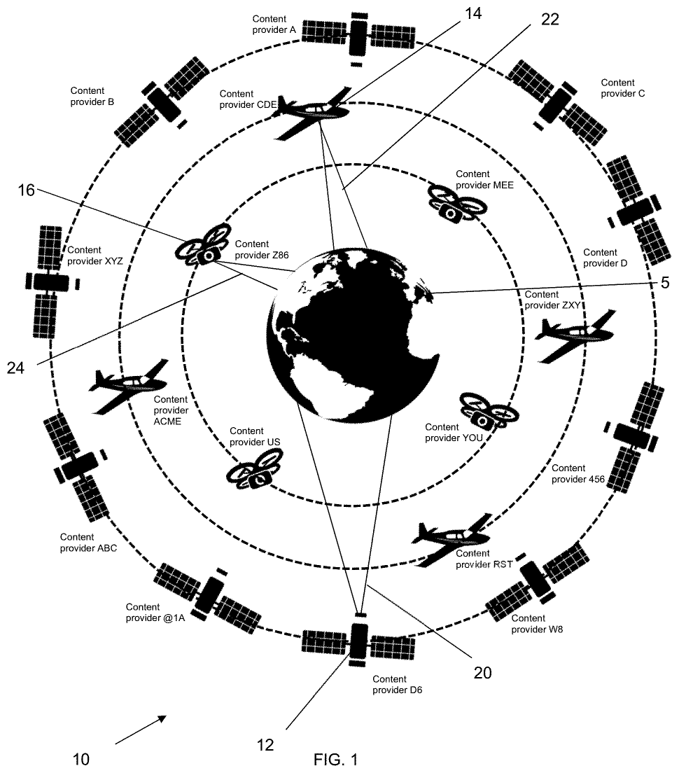

Referring to FIG. 1, there is a schematic diagram of image collectors 10 in operation around the globe 5. These image collectors 10 comprise, for example, one or more satellites 12, one or more aircraft 14 and one or more unmanned vehicles (commonly referred to as drones) 16. The image collectors 10 operate at different altitudes from the surface of the globe 5. They have different technologies implemented in their image capturing devices, such as for example, images in the visible light spectrum, infrared bands, through to radar. Depending on the technology they will have a differing range of zooming and due to their differing altitude will have differing fields of view 20, 22 and 24, resulting in images of differing in area and resolution. The area that they view at any given time is also dictated by their flight path, which in some cases is highly selectable (eg drones), and in other cases is relatively fixed (eg satellites). Further, they will have differing atmospheric interference, such as cloud cover, smog, smoke and obstacles. Further still they are operated by differing entities, which allow access to image content in differing ways. The types of image may also differ, by being still images or moving video images.

These image collectors 10 collect their various images and they are stored as data by numerous access providers for later access. In the context of the present invention, image data encompasses still images and video images, but may be discriminated according to the needs of the user. Further, the image collectors 10 may collect information, which is not necessarily readily recognised or visualised as an image, for example range data which may be used to define a topology. Such information, is not intended to be limiting, and such information stored as data is intended to fall within the scope of the present invention. As such, aerially/remotely collected data is intended to fall within the meaning of the term image in the context of this specification.

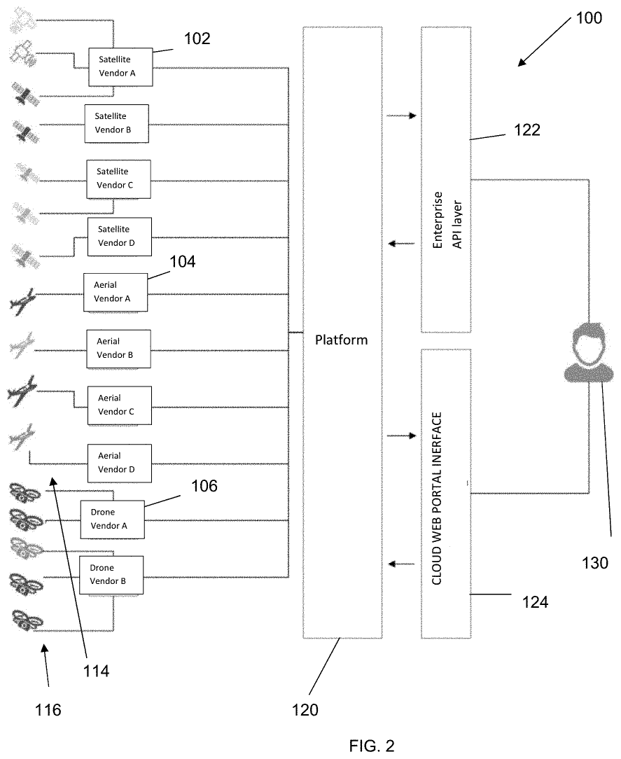

FIG. 2 is a schematic block diagram of a system 100 for accessing image data according to an embodiment of the present invention. The system comprises image collectors 10 of various types, including satellites 112, aircraft 114 and drones 116. Other types of image collectors are envisaged, for example hot-air balloons. Respective images vendors, such as one or more satellite vendors, aerial vendors and drone vendors, with respective vendor examples being 102, 104 and 106, are shown. Each vendor may have access to images from one or more images collectors 10. An access system 120 is arranged to be able to access the data of the vendors by an on-line communications medium, such as the Internet. The access system 120 comprises vendor interface modules to connect to and access to the vendors 102, 104 and 106, and either one or both of a user facing enterprise API module 122 and a user facing online (cloud) web portal interface module 124. The user facing modules 122 and 124 allow one or more users 130 to request and access images from the various vendors 102, 104 and 106, via the interface system 120. The user 130 may be a person, or another computer system.

The interface system 120 for accessing image data may be for example, a virtual machine computer, a personal computer, a server or a ‘cloud’ server. In an embodiment the interface system 120 comprises a central processing unit based system. The central processing unit may be physical, logical or virtual CPUs, and may be configured to have a plurality of discrete processors or processors with multiple processing cores. The central processing unit is interfaced to a storage drive which may comprise one or more typical storage drives, such as by way of example, hard disk drives or solid state drives. An operating system is stored in the storage drive in order to provide instructions to the processor. The central processing unit is also in communication with a random access memory (RAM). The RAM is typically used as temporary storage and working space for the operating system.

The central processing unit is also in communication with a network interface module, such as by way of example, a local area network adaptor or a wireless network adaptor. The network interface module allows the processor to connect to a computer network, such as for example, the Internet. A computer program, described below, or data for the computer program may be obtained from the computer network or from a non-transitory computer readable storage medium accessed through an interface device.

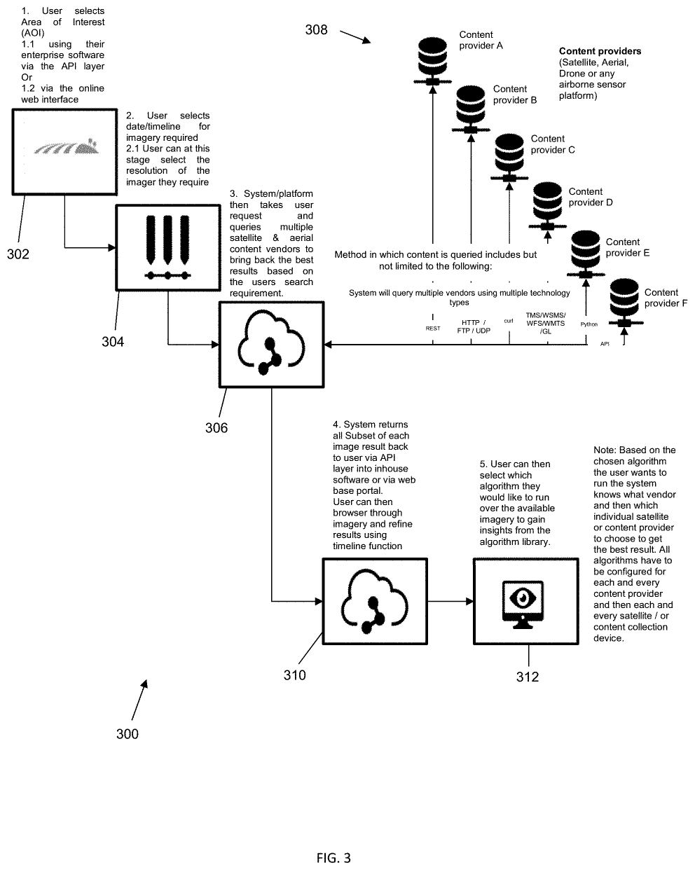

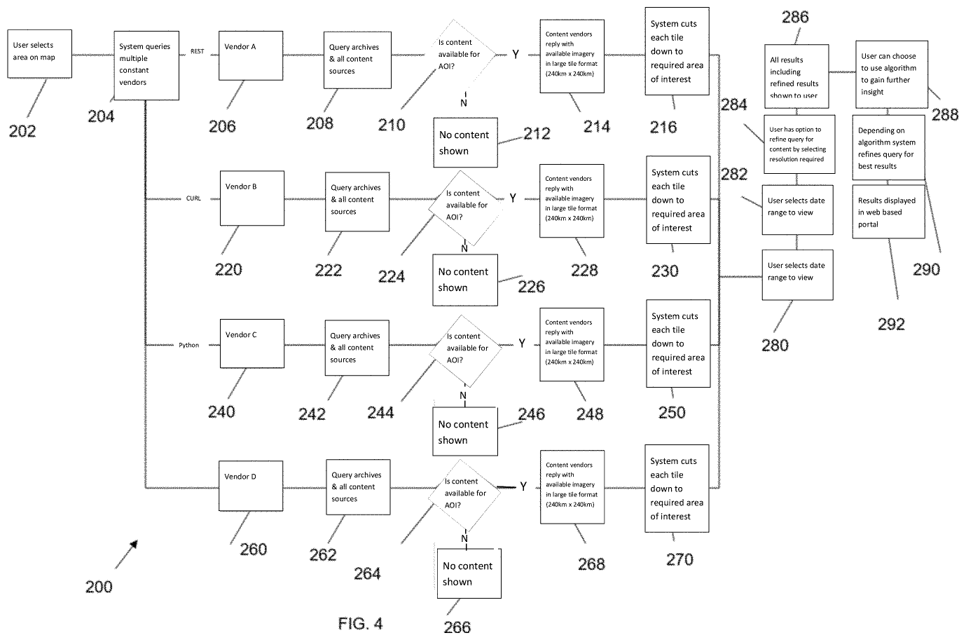

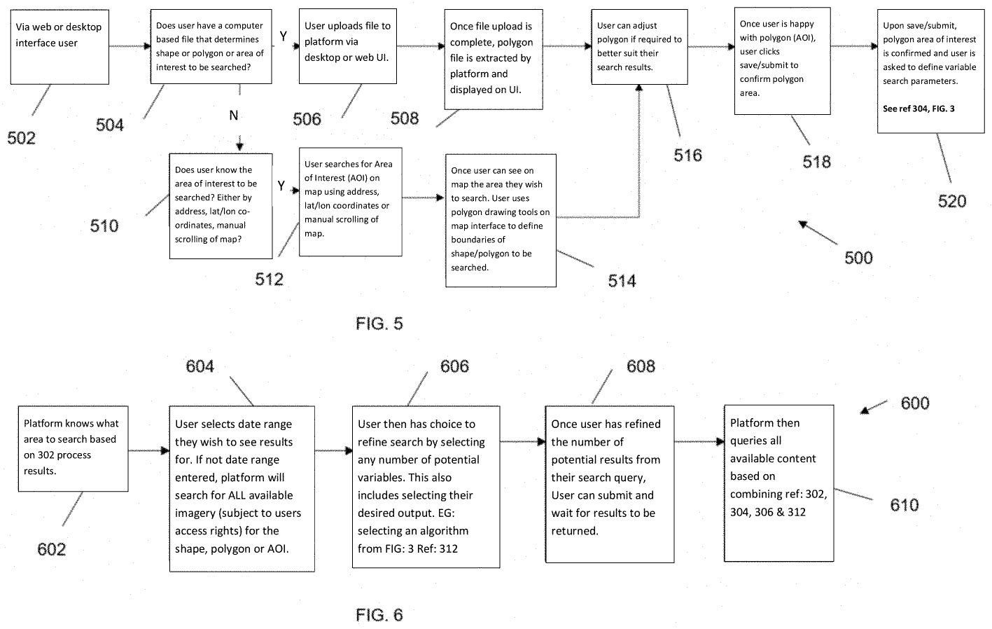

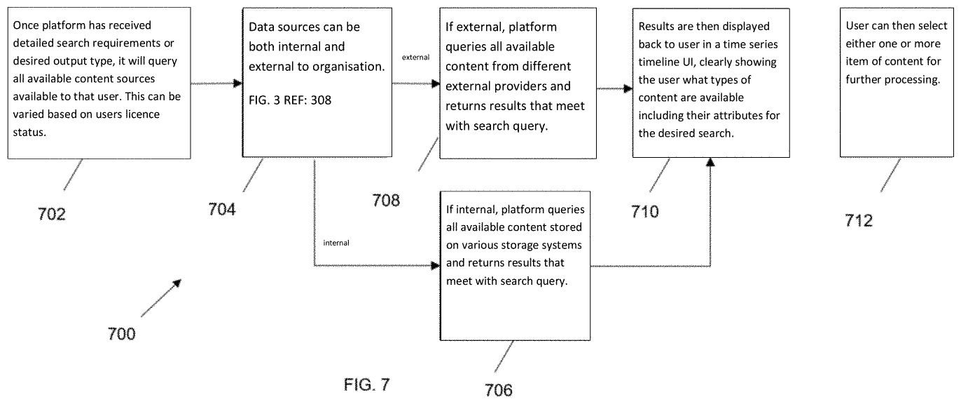

The computer program is installed upon the computer of the interface system 120 and comprises executable instructions for controlling the processor. In an embodiment, the computer program configures the computer to operate as a plurality of functional “processing” modules 300 described further below in relation to FIG. 3, which operate, in an embodiment, to perform the method described in relation to FIG. 4 further below.

Referring to FIG. 3, the interface system 120 for accessing image data is shown. The system 120 comprises a user interface module 302, a time frame selection interface 304, a query module 306, an image evaluation module 310 and optionally an insight module 312.

The user interface module 302 allows the user 130 to interact with the interface system 120. The user interface module 302 provides the user facing modules 122 and 124. Module 122 allows the user 130 to use their own enterprise software via an Application Programming Interface (API). Module 124 allows the user 130 to interact with the interface system 120 via a web interface. Module 124 comprises a web server that creates an instance of a website to provide a web page(s) to the user's browser running on the user's computer.

User interface module 302 allows the user 130 to select an area of interest. The area of interest defines an area on the surface of the globe for which they wish to have access to images captured by the image collectors 112, 114 and/or 116.

The time frame selection interface 304 allows the user 130 to select a date and timeline for imagery required. For example, the time frame may be the most recent image(s) available for the selected area of interest; it may be the image(s) available for the selected area of interest approximately 1 year ago, or it may be the image(s) available for the selected area of interest over the last 5 years. The user 130 has wide discretion to select the time frame so as to best suit their needs. In an embodiment the time frame, may be into the future, in which case the future part of the time frame will form a request for future data, which is described further below.

Optionally the user may also select resolution required of the image(s), spectrum, such as visible light images or infrared images (eg. NIR or SWIR), or other parameters.

Thus the interface system 120 has received from a user a query to access data, wherein the query comprises data parameters comprising one or more time frames for the images of the data, one or more geographic areas of the images of the data, and optionally one or more other parameters of the images of the data, such as resolution or spectrum of the images.

The query module 306 is arranged to format the data query according to a query format requirement of each of a plurality of data providers 102, 104, 106. The query module 306 also comprises an interface configured according to the requirements of the data providers 102, 104, 106, such that it can connect to and interface with a data server 308 of each of the respective data providers 102, 104, 106. The interface may be configured to use protocols such as for example Representational State Transfer (REST), HTTP/FTP/UDP, cURL, TMS/WSMS/WFS/WMTS/GL, Python, or some other API. It will be understood that the interface format requirement is different to the query format requirement.

The query module 306 is configured to make the respective appropriately formatted queries of the respective data servers 308. The query module 306 is also arranged to receive a response from the respective data servers 308, which may be that the requested data is not available, or that the data is available, or simply a response that includes the requested data. In the case that the response is that the data is available, then the data is requested of the respective data server 308 in the appropriate format for that data server. The returned data is received in the format as provided by the respective data server 308. It will be understood that each data server will not necessarily have the same query format requirements or the same interface format requirements. Thus, the query module 306 needs to know the respective format requirement of that particular data server and must format the query according to those respective requirements.

The image evaluation module 310 is configured to collate the returned data. In one embodiment the result data is cached. The image evaluation module 310 is also configured to present the results data to the user 130 via the user interface, and more specifically via the appropriate user facing module 122 or 124. The image valuation module 310 presents the returned data to the user 130, preferably, in a unified format so that the user 130 can evaluate the returned data. For example, the user 130 can then browse through imagery. The user 130 may wish to refine the results using the timeline module 304, or update the area of interest. In that case retrieved images no longer meeting the query criteria are removed from the cache and if additional querying of the data servers 308 is required then this can be handled by the query module 306, with the additional results collated in the cache.

In an embodiment, the optional insight module 312 is configured to apply one or more insight algorithms to the cached data to provide an insight into the images in the unified format. The user 130 can switch algorithms available in an algorithm library of the module 312 that they wish to apply to the available imagery to gain insights. For example, the insight might evaluate changes to the area of interest over the defined period of time, or the insight might evaluate the amount of greenery in an image. The appropriate algorithm to achieve these insights is selected from the algorithm library and applied to the cashed area of interest. These are but two of many possibilities. The user can see or download the result via module 122. Alternatively, the user 130 may apply their own insight algorithms in their own enterprise software once the returned results are downloaded to the user's enterprise computer, via the module 122.

FIG. 4 is a flow chart of a method 200 of accessing image data according to an embodiment of the present invention. Typically, the method will be implemented using the interface system 300.

The method commences at 202 by the user 130 being presented with a map and the user 130 selecting an area of interest on the map. A time frame may also be entered, although by default the time frame may be the “most recent image(s) available”.

The interface system 120 then formats a query from the selected area of interest and time frame so as to meet the requirements of the image data providers. The queries are then sent to the multiple data providers at 204 using the respective appropriate protocol/format.

For example, the interface system 120 queries a vendor A at 206 using the REST protocol; the interface system queries vendor B at 220 using cURL protocol; the interface system 120 queries vendor C at 240 using a Python protocol, and the interface system 120 queries vendor D at 260 using another protocol.

Vendor A then queries its archives and content sources at 208 for the search criteria. It checks at 210 whether the content is available. If the content is not available it returns a message at 212 that there is no content available. If content is available, then content vendor A replies with available imagery, such as in the tile format (240 km×240 km) at 214. The tile may be for example in an image format (eg GeoTIFF). The interface system 120 then cuts (crops) each tile down to the required area of interest at 216.

Vendor B also queries its archives and content sources at 222 for the search criteria. It checks at 224 whether the content is available. If the content is not available it returns a message at 226 that there is no content available. If content is available, then content vendor B replies with available imagery, such as in the tile format at 228, or of a different area and not necessarily of the same area as vendor A. The tile format may be in a different image format to Vendor A, such as for example CEOS image format. It may be of a different resolution to the image of Vendor A, or have different associated properties. The interface system 120 then cuts each returned tile down to the required area of interest at 230.

Vendor C also queries its archives and content sources at 242 for the search criteria. It checks at 244 whether the content is available. If the content is not available it returns a message at 246 that there is no content available. If content is available, then content vendor C replies with available imagery, such as in the tile format at 248. Again, this may be a different size of a different area in a different format, eg a raster format, such as ESRI Grid. The interface system 120 then cuts each tile down to the required area of interest at 250.

Vendor D also queries its archives and content sources at 262 for the search criteria. It checks at 264 whether the content is available. If the content is not available it returns a message at 266 that there is no content available. If content is available, then content vendor D replies with available imagery, such as in the tile format at 268. Yet again, this may be a different size of a different area in a different format, eg a vector such as TIGER format. The interface system 120 then cuts each tile down to the required area of interest at 270.

The images may be in different formats, different sizes, at different resolutions, of different spectra, with different pixel bit depths at different times, with different meta data.

The interface system 120 collates the available images from the various vendors, in this example Vendors A, B, C and D, reformats them to a common displayable format, and shows them in sequence in a timeline bar at 280. The user 130 then selects a date range to view at 282. The user 130 has the option to refine the query content by selecting resolution required at 284. In one embodiment the data is processed to exclude those images that do not meet the resolution requirement, or a processed to reduce the resolution to that required if it exceeds the required resolution. In an embodiment images with cloud cover over a user selected, or a default, amount may be excluded.

The refined results are shown to the user 286. User can choose to use an algorithm to get further insights at 288. Depending on the algorithm, the system refines the query for the best results at 290. Results are displayed to the user in a web portal 290. Alternatively, or in addition, they can be downloaded to the user's enterprise software.

Referring to FIG. 5, a method 500 performed by user interface module 302 is described in more detail. The user accesses the user interface via a website 124 or via a desktop interface 122 at 502. The interface then checks with the user as to whether the user has a computer based file that determines a shape, polygon or area of interest to be searched at 504. If yes, at 506 the user uploads the file to the platform 120. The platform then extracts the area of interest at 508 and displays to via interface 122/124 to the user.

If no, the user is asked for the area of interest by for example street address, latitude/longitude coordinates or manual scrolling on a map at 510. The user search for the area of interest at 512 from this entered information. The user is then shown the area of interest on a map. The user can draw a polygon (eg a rectangle) on the map to define the boundary of the area to be searched at 514.

At 516 the user can adjust the polygon if required. Once happy with the selected polygon the area can be submitted for searching at 518. The intersection of the line of the polygon and the map's pixel coordinates define the area of interest. The next step is to define variable search parameters at 520.

Referring to FIG. 6, a method 600 performed by time frame selection interface 304 is described in more detail. The starting point of this method 600 is that the platform knows the area of interest at 602. The user then selects a date range to see the results for at 604. As a default if no date range is selected then the search can be for all data in the area of interest.

At 606 the user is given the choice to refine the search by selection from variables, such as data image resolution, date and time, percentage cloud cover, sensor type and/or algorithm to output the search result. The user also selects their desired output format type. At 608 the user submits the search to the platform 120. He next step 610 is for the platform to perform the search.

Referring to FIG. 7, a method 700 performed by query module 306 is described in more detail. With the area of interest and time frame as well of other search parameters at 702 the platform will then format queries for each possible data source available to the user. This might be based on a user's licence status with each data source. At 704 the data sources may be internal to the platform or external. In the case of an internal data source 706 the platform queries stored content and returns results that meet the search query. In the case of an external data source 708 the platform queries external data sources (such as Vendors A, B, C and D) and returns results that meet the search query. At 710 the results that meet the search criteria are displayed to the user in a time series timeline user interface showing the user what types of content are available including their attributes for the desired search. At 712 the user can select one or more items of content for further processing.

In an embodiment, processing the retrieved images comprises stitching together data retrieved from different data providers so as to provide one or more images of a combined geographic area, as defined by the area of interest. In an embodiment, processing the retrieved image data comprises processing data from different data providers so as to provide one or more multispectral images of a combined geographic area.

In an embodiment, the processing comprises combining different spectral images into multi-spectral images each image being of a geographic area in a given time frame from different spectral images from different data providers. For example, NIR images might be available from one data provider and SWIR images may be available from another vendor. The NIR and SWIR images could be combined to provide a broader IR spectrum of images.

In an embodiment, the received query further comprises a request for future content. In an embodiment, the method further comprises formatting the request for future content according to the requirement of each of the respective data providers.

In an embodiment, the method further comprises sending the formatted request for future content to one or more of the data providers, optionally according to a pre-selection criteria. In an embodiment, the pre-selection criteria select data providers to be omitted from those to which the formatted request for future content is made which are able to be determined in advance will not have be able to provide the future content according to required data parameters required of the future content.

In an embodiment, the method further comprises receiving a response from each data provider, where the response indicates whether the respective data provider is able to provide the future content according to the required parameters. In an embodiment, the method further comprises selecting one or more of the data providers to provide the future according to the responses. In an embodiment, the method further comprises retrieving data comprising the future content from the selected providers, as and when it is available.

It is envisaged that over time the number of different protocols and formats used by different vendors will converge. A single standard for requesting imagery may emerge. Nevertheless, the present invention will still be applicable because of the different time periods at which the different vendors will have images and the different image collectors will obtain different types of images, include having different views of view and different resolutions.

The present invention provides the advantage of being able to obtain image data from a variety of sources, where the images available are spread over these different sources, potentially in different formats, and each relates to a different area of interest, and/or is taken at a different time, and/or has other differing properties, such as resolution and/or differing spectral capture.

Modifications may be made to the present invention within the context of that described and shown in the drawings. Such modifications are intended to form part of the invention described in this specification.

What is claimed:

1. A method of accessing image data comprising:
receiving a query to access data from a user, wherein the query comprises data parameters comprising one or more geographic areas of the images of the data, and/or one or more time frames for the images of the data;
formatting the data query according a requirement of each of a plurality of data providers;
sending the respective formatted query to each of the data providers;
receiving a response from each data provider, where the response indicates whether the respective data provider has data that meets the respective formatted query;
for those data providers that indicate that they have data that meets the respective formatted query, retrieving the data that meets the respective formatted query using a data transfer protocol suitable for the respective data provider;
collating the retrieved data from the plurality of data providers;
sending the retrieved data to the user.

2. A method according to claim 1, wherein the query one or more other parameters of the images of the data, wherein the parameters comprise image resolution or spectrum of the images.

3. A method according to claim 1 or 2, further comprising converting the collated data into a common format.

4. A method according to any preceding claim, wherein the requirement of each data provider comprises a query format.

5. A method according to any preceding claim, wherein the requirement of each data provider comprises the data interface format.

6. A method according to any preceding claim, wherein receiving the query of one or more geographic areas comprises receiving, modifying or verifying the size, shape and position of a polygon image on a map so as to indicate the area of interest of the query.

7. A method according to any preceding claim, wherein the retrieved data from each data provider is processed from the respective retrieved format into a format specified in the query before being sent to the user.

8. A method according to any preceding claim, wherein the processing comprises stitching together data retrieved from different data providers so as to provide one or more images of a combined geographic area.

9. A method according to any preceding claim, wherein the processing comprises changing the resolution of images in data retrieved from different data providers so as to provide images of a consistent resolution.

10. A method according to any preceding claim, wherein the processing comprises sequencing images in time order from the different data providers.

11. A method according to any preceding claim, wherein the processing comprises combining different spectral images into multi-spectral images, each of the images being of a geographic area in a given time frame from different spectral images from different data providers.

12. A method according to any preceding claim, wherein the received query further comprises a request for future content. In an embodiment, the method further comprises formatting the request for future content according to the requirement of each of the respective data providers.

13. A method according to any preceding claim, wherein the method further comprises sending the formatted request for future content to one or more of the data providers, optionally according to a pre-selection criteria.

14. A method according to any preceding claim, wherein the pre-selection criteria selects data providers to be omitted from those to which the formatted request for future content is made which are able to be determined in advance will not have be able to provide the future content according to required data parameters required of the future content.

15. A method according to any preceding claim, wherein the method further comprises receiving a response from each data provider, where the response indicates whether the respective data provider is able to provide the future content according to the required parameters.

16. A method according to any preceding claim, wherein the method further comprises selecting one or more of the data providers to provide the future according to the responses.

17. A method according to any preceding claim, wherein the method further comprises retrieving data comprising the future content from the selected providers, as and when it is available.

18. A method of requesting future image data comprising:
receiving a query to access data from a user, wherein the query comprises data parameters comprising one or more geographic areas of the images of the data;
formatting the data query according to a requirement of each of a plurality of data providers;
sending the respective formatted query to each of the data providers;
receiving a response from each data provider, where the response indicates whether the respective data provider can provide the data that meets the respective formatted query;
for those data providers that indicate that they have data that meets the respective formatted query, retrieving the data that meets the respective formatted query using a data transfer protocol suitable for the respective data provider;
collating the retrieved data from the plurality of data providers;
sending the retrieved data to the user.

19. A method according to claim 18, wherein the received query further comprises a time frame required for the future image data.

20. A method according to claim 18 or 19, wherein the pre-selection criteria selects data providers to be omitted from those to which the formatted request for future content is made which are able to be determined in advance will not have be able to provide the future content according to required data parameters required of the future content.

21. A method according to any one of claims 18 to 20, wherein the method further comprises selecting one or more of the data providers to provide the future according to the responses.

22. A method according to any one of claims 18 to 21, wherein the method further comprises retrieving data comprising the future content from the selected providers, as and when it is available.

23. A system for accessing image data comprising:
a receiver for receiving a query to access data from a user, wherein the query comprises data parameters comprising one or more time frames for the images of the data, and/or one or more geographic areas of the images of the data;
a first processor for formatting the data query according to a requirement of each of a plurality of data providers;
a transmitter for sending the respective formatted query to each of the data providers;
a receiver for receiving a response from each data provider, where the response indicates whether the respective data provider has data that meets the respective formatted query;
a receiver for retrieving the data that meets the respective formatted query using a data transfer protocol suitable for the respective data provider from those data providers that indicate that they have data that meets the respective formatted query;
a second processor for collating the retrieved data from the plurality of data providers;
a transmitter for sending the retrieved data to the user.

24. A system for accessing image data comprising a processor configured to:
receive a query to access data from a user, wherein the query comprises data parameters comprising one or more time frames for the images of the data, and/or one or more geographic areas of the images of the data;
format the data query according to a requirement of each of a plurality of data providers;
send the respective formatted query to each of the data providers;
receive a response from each data provider, where the response indicates whether the respective data provider has data that meets the respective formatted query;
retrieve the data that meets the respective formatted query using a data transfer protocol suitable for the respective data provider from those data providers that indicate that they have data that meets the respective formatted query;
collate the retrieved data from the plurality of data providers;
send the retrieved data to the user.

25. A system for accessing image data comprising:
means for receiving a query to access data from a user, wherein the query comprises data parameters comprising one or more time frames for the images of the data, and/or one or more geographic areas of the images of the data;
means for formatting the data query according to a requirement of each of a plurality of data providers;
means for sending the respective formatted query to each of the data providers;
means for receiving a response from each data provider, where the response indicates whether the respective data provider has data that meets the respective formatted query;
means for retrieving the data that meets the respective formatted query using a data transfer protocol suitable for the respective data provider from those data providers that indicate that they have data that meets the respective formatted query;
means for collating the retrieved data from the plurality of data providers;
means for sending the retrieved data to the user.

26. A computer program embodied in a computer readable tangible media comprising instructions for controlling a computer processor to:
receive a query to access data from a user, wherein the query comprises data parameters comprising one or more time frames for the images of the data, and/or one or more geographic areas of the images of the data;
format the data query according to a requirement of each of a plurality of data providers;
send the respective formatted query to each of the data providers;
receive a response from each data provider, where the response indicates whether the respective data provider has data that meets the respective formatted query;
retrieve the data that meets the respective formatted query using a data transfer protocol suitable for the respective data provider from those data providers that indicate that they have data that meets the respective formatted query;
collate the retrieved data from the plurality of data providers;
send the retrieved data to the user.
